(19) United States
(12) Patent Application Publication
(10) Pub. No.: US 2025/0378491 A1
(43) Pub. Date: Dec. 11, 2025

(54) Smart Contracts for Collaborative Impact Assessment

(71) Applicant: Microsoft Technology Licensing, LLC, Redmond, WA (US)

(72) Inventors: Aritra DattaGupta, Redmond, WA (US); Marwan E. Jubran, Kirkland, WA (US)

(21) Appl. No.: 18/734,936

(22) Filed: Jun. 5, 2024

(51) Int. Cl. G06Q 40/04; G06Q 10/0633

(52) U.S. Cl. CPC G06Q 40/04; G06Q 10/0633; G06Q 2220/00

(57) ABSTRACT

A method, computing system, and computer program product for generating a plurality of smart contracts, each of the plurality of smart contracts associated with a respective service team, and each of the plurality of smart contracts identifying components impacting each respective service team. One or more component changes associated with a proposed design are received. The one or more component changes are validated against components impacting each respective service team to identify impacts associated with the proposed design by at least a portion of the plurality of smart contracts.

### BACKGROUND

Cloud computing environments are distributed and heterogeneous in nature. In order to build a new cloud, enlarge an existing one, or introduce new feature sets, a large diversity of software and hardware components may often be required. These components are in turn supplied by various vendors and service teams, potentially across multiple organization. All of the components of the new, expanded, or changed cloud must work together seamlessly to provide the best operation and customer experience. The complexity of this process introduces numerous risks in terms of resource vulnerabilities and incompatibilities, both during the operationalization process as well as after releasing the new capacity to production.

Throughout the enormously complex process of bringing new capacity or features to market, every single change has the potential to impact or derail the rest of the pipeline, for example in terms of hardware reliability, performance, safety, security, and compliance, provisioning hardware or capacity, cycle time and variance, timelines, etc.). Such unexpected change can lead to substantial loss in revenue, degraded customer experience (performance issues, reliability or quality issues, security issues, etc.), or the slipping of key timelines.

### BRIEF DESCRIPTION OF THE DRAWINGS

FIG. 1 is a flow chart of one implementation of an impact assessment process;

FIG. 2 is a diagrammatic view of an example cloud computing environment;

FIG. 3 is a diagrammatic view of one implementation of the impact assessment process of FIG. 1;

FIG. 4 is a diagrammatic view of computer system and the cloud storage ownership process coupled to a distributed computing network.

Like reference symbols in the various drawings indicate like elements.

### DETAILED DESCRIPTION OF THE EMBODIMENTS

Implementations of the present disclosure allow the impact of a new design on the various teams that must support and/or implement the design to be assessed early in the design or development process of the design. For example, in a cloud computing environment, the capacity of the cloud computing environment is ever changing – adding new capacity, adding new hardware, replacing old hardware, etc. The capacity of the cloud computing environment may include the hardware components implementing the cloud computing environment, such as servers, networking devices, and the like. Additionally, the capacity of the cloud computing environment may also include feature offerings, such as virtual machine size or capabilities available within the cloud computing environment. When utilizing existing hardware or feature offerings, the various aspects may already be fully supported by existing software, firmware, and physical infrastructure. However, when new components (e.g., hardware components, or software components) are introduced as part of the change in capacity, or new design, such new components may not be adequately supported (or supported at all) by existing software, firmware, or physical infrastructure to allow the implementation of the new design. As such, it may be necessary to develop, or modify, firmware, software, processes, and/or other hardware to support the new hardware components. Similarly, existing software may need to be modified, or new software developed, to appropriately utilize and/or support new software components. Various additional and/or alternative developments and/or modifications may be required to ensure proper functioning and support of the new components.

As will be described in greater detail below, smart contracts may be leveraged for identifying service teams that may be impacted by new components of a design (i.e., components that do not have existing support). In some implementations, service teams that may be impacted by new components of a design may be identified early in the development process, including as early as during the planning phase of the development process. As will be understood, and ecosystem, such as a cloud computing ecosystem, may involve many service teams supporting the ecosystem, sometimes ranging in the hundreds of different service teams. The service teams may include for example, operating system service teams responsible for developing and/or supporting operating systems running in, and/or implementing, the cloud computing system; networking service teams responsible for managing networking architecture (e.g., developing and/or managing networking capabilities for the cloud computing environment), feature teams responsible for developing and managing customer-facing features of the cloud computing environment; and the like. As noted, the number of teams involved in developing, managing, and operating a cloud computing environment may number in the tens, or even hundreds.

As will be described in greater detail below, implementations of the present disclosure may include onboarding various service teams to create respective smart contracts associated with each of the service teams. The smart contracts may, in part, identify component changes that may impact each of the respective service teams. That is, if a new design includes a component (hardware or software) that is not fully supported by the existing cloud computing environment, one or more of the service teams may have to provide support for the component that is not fully supported. As generally discussed above, providing support for the component may include, for example, developing new software and/or modifying existing software to support the component, developing new firmware and/or modifying existing firmware to support the component, looking up existing processes or establishing new processes to manage the hardware, modifying or replacing physical infrastructure of the cloud computing environment to support the component, and/or various other tasks to ensure the component is properly support for operation in the cloud computing environment. When a new design is proposed, the design may be evaluated to determine if any of the components of the new design are new components (e.g., not fully supported by the existing cloud computing ecosystem). For any such new components, at least a portion of the smart contract may validate the new components to identify the impacts associated with the new design. This validation may occur early in the design or development of the proposed design, rather than after the design has been built and is being tested, or even after the design has been rolled out. As such, appropriate planning and decision making can be made.

The details of one or more implementations are set forth in the accompanying drawings and the description below. Other features and advantages will become apparent from the description, the drawings, and the claims.

### Impact Assessment Process

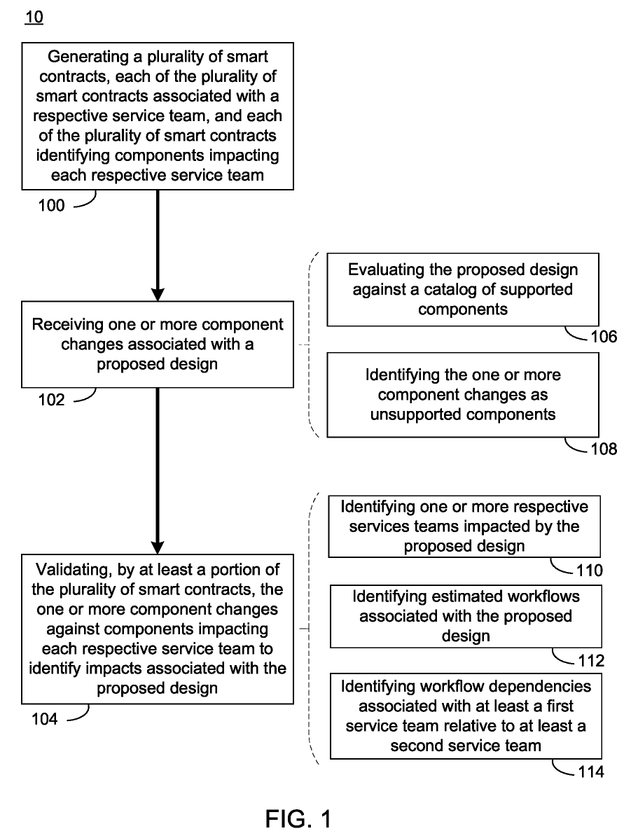

Referring to FIGS. 1-4 impact assessment process 10 generates 100 a plurality of smart contracts, each of the plurality of smart contracts associated with a respective service team. Each of the plurality of smart contracts identifies components impacting each respective service team. One or more component changes associated with a proposed design are received 102. At least a portion of the plurality of smart contracts validate 104 the one or more component changes against components impacting each respective service team to identify impacts associated with the proposed design.

In some implementations, impact assessment process 10 may be utilized in connection with assessing an impact associated with a capacity provisioning process within a cloud computing environment. For example, the buildout may include provisioning new capacity, such as providing new features within the existing cloud computing environment, adding new software to the cloud computing environment, providing new hardware features and/or capabilities to the cloud computing environment. In such situations, new components may be added to the cloud computing environment, for example, new hardware components, whether completely new server designs, or existing server designs with a portion of the hardware components being replaced by new hardware components (e.g., different processors, motherboards, storage devices, networking devices, etc.). It will be appreciated that provisioning new capacity within the cloud computing environment may also include providing other new hardware, such as power management devices, networking devices, as well as a myriad of additional hardware components. Even when a pool of existing capacity is being enlarged, which may be similar to / the same as already deployed forms of capacity within the cloud computing environment, various changes to hardware and/or software may occur. For example, the existing form of capacity may be been deployed in the past (months ago, years ago, etc.). Accordingly, the pool of capacity for this existing form may be enlarged using hardware that may generally correspond to the existing hardware, but may be of a newer iteration. Additionally / alternatively, expanding the pool of an existing form of capacity may include utilizing completely new and different hardware, which is simply capable of supporting the existing form of capacity.

It will be noted that reference to new and/or different hardware may include, but is not intended to exclusively indicate, e.g., that a new server is entirely different from an existing server, although such implementations are considered within the scope of this disclosure. For example, the new and/or different hardware may only include, e.g., a different memory device, a different processor iteration, a commensurate hardware component provided by a different manufacture, a different networking component, etc., implemented in a hardware platform (e.g., server, network switch, etc.) that is otherwise the same as an existing hardware platform. Similarly, new and/or different software may, but does not exclusively, indicate a completely new piece of software, but may also include a new version of an existing piece of software, a customized instance of an existing piece of software, etc. It will be appreciated that the foregoing is similarly applicable to firmware and/or other aspects of the cloud computing environment.

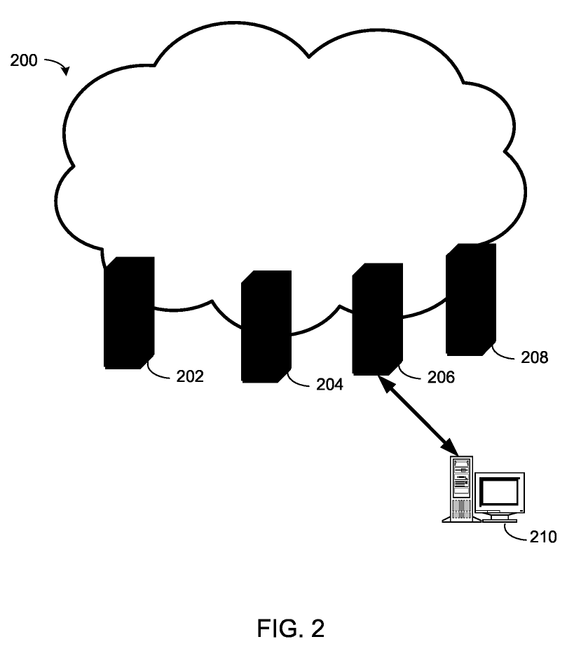

Referring also to FIG. 2, an illustrative example embodiment of a cloud computing environment 200 is shown that may, for example, provide cloud computing resources to various clients. For example, cloud computing environment 200 may include one or more nodes (e.g., nodes 202, 204, 206, 208) that may each potentially host one or more virtual machines. Each of the nodes 202, 204, 206, 208 including computing devices that may have various hardware configuration to enable the nodes to host respective virtual machines, and/or otherwise provide cloud computing resources for users/customers (e.g., via user computing device 210). The various nodes 202, 204, 206, 208 may include, but are not limited to, servers, networking devices, storage devices, memory devices, power management devices, as well as a great variety of supporting hardware components, and/or other hardware components, as will be readily understood. Additionally, any of the various nodes 202, 204, 206, 208 may execute a wide variety of software applications.

Consistent with some implementations, smart contracts may be utilized to provide visibility of proposed changes (e.g., capacity or hardware provisioning or modification within cloud computing environment 200) that may create issues with new product introduction. Further, in some implementations, smart contracts may be utilized to assess impacts of some changes to various service teams within the cloud computing ecosystem associated with a proposed new tech hardware or existing hardware. As used herein, a service team may include any division, team, group, or individual who may be responsible for planning, developing and/or supporting any aspect of the cloud computing environment, including facilitating proper operation, integration, lifecycle support, etc., of any aspect of hardware or software involved in the cloud computing environment, and/or particular product offerings within the cloud computing environment. It will be appreciated that while features of the present disclosure may be described in the context of a cloud computing environment, the present disclosure is equally application to other fields of use.

As generally discussed above, according to an implementation impact assessment process 10 may generate 100 a plurality of smart contracts (e.g., smart contracts 408, generally). As is generally known, a smart contract may be thought of as including a combination of technology and promises communicated via interfaces to formalize and secure relationships. For example, smart contracts may be thought of as code-based programs that may be used to generate contractual effects amongst various parties. As such, smart contracts may achieve enforceability by tamper-proof execution code to develop an assured impact assessment capability, and add formal checkpoints in a development process. Each of the plurality of smart contracts 408 may be associated with a respective service team. Further, each of the plurality of smart contracts 408 may identify components impacting each respective service team. For example, each service team may be onboarded onto impact assessment process 10 by identifying components within cloud computing environment 200 that the respective service team is impacted by. Herein, a service team may be impacted by a component within cloud computing environment if a change to the component may result in a workflow for the respective service team. A workflow for the service team may include, but is not limited to, the need to write or modify software and/or firmware to implement, support, or interoperate with the component, and/or modify or change another component to implement, support, or interoperate with the component. Accordingly, a change and/or problem with the component impacting each respective service team may result in a work item, expense, or activity for the respective service team.

As generally discussed hereinabove, components may include hardware components, software components, firmware components, processes, or the like. Additionally, each of the plurality of smart contracts 408 may identify components impacting the respective service teams at different levels of granularity. For example, at a high level of granularity, a networking service team may identify that any change in a networking device will impact the networking service team, thereby providing a high-level indication of components that will impact the networking service team. Further, for example, a service team may identify that not only will a change to the motherboard impact the service team, but even a change to the chipset will impact them, thereby providing a finer degree of granularity. It will be appreciated that courser and finer levels of granularity may be utilized.

According to different implementations, various service teams may identify components impacting them in a variety of manners. For example, different service teams may identify components impacting them from a catalog of components associated with the cloud computing environment (e.g., catalog 409). In an example, catalog 409 may include a catalog of all and/or a portion of components associated with cloud computing environment, and/or a portion thereof. In some implementations, a respective catalog may be associated with different aspects of cloud computing environment (e.g., different server classes, cloud computing families, market segments, etc.), such that a service team can identify components of a cloud computing environment that are relevant to that particular service team. Further, catalog 409 may provide different levels of granularity, e.g., which may allow service teams to specify component impacting the service team at different levels of granularity. For example, a networking service team may generally identify that any networking component may impact the service team. Additionally / alternatively a networking service team (and/or a subset within a larger networking service team) may identify that only top of rack network switches impact that particular service team.

In some implementations each of the plurality of smart contracts identify an impact associated with the respective service team. For example, in addition to identifying that a change in a component may impact a given service team, the service team may also identify the nature of the impact. For example, a change in a component may require that a service team produce software for supporting the component. In another implementation, a change in a component may require the replacement of other components, e.g., to provide interoperability. This may be the case, for example, in which physical infrastructure, such as cabling arrangements connecting server racks, may need to be changed. In some implementations (such as the foregoing example of changing cabling arrangements), and impact for a service team may include both a work item and an expenditure (e.g., the cost of the new cabling arrangement and the work to replace an other cabling arrangement with the new cabling arrangement). It will be appreciated that service teams may experience various additional and/or alternative impacts.

Consistent with some implementations, the impact associated with the respective service team may include an estimated workflow assessment associated with respective service team. For example, in addition to identifying that a service team may be impacted by a change in a component, the service team may identify the nature of the impact (e.g., work item, expenditure, etc.), as well as a magnitude of the impact. The estimated workflow assessment may include a general estimate, such as small impact, medium impact, large impact. Additionally / alternatively the estimated workflow assessment may be provided at a higher level of granularity. For example, a operating system service team may indicate that a change in a motherboard may necessitate four months of development to support a new motherboard, or a given number of manhours, or other metric, which may be provided at different levels of granularity. Similar estimates may be provided for expenditure, or cost, impacts. It will be appreciated that a service team may identify components that impact the service team and estimated workflow assessments associated with the impacts in a proactive manner (e.g., when the service team is onboarding onto impact assessment process 10) rather than in response to a particular known component change. As such, the estimated workflow assessment may be provided as a best guess and/or at a more general level of granularity. However, in other implementations a service team may be able to provide an estimated workflow assessment at a higher level of granularity. For example, this may be the case with components impacting the service team are identified at a higher level of granularity.

It will be appreciated that, in some implementations, various components of the cloud computing environment may be supported by more than one service team, and/or addressing an impact of a component change by one service team may therein impact another service team. As such a change to one component may impact multiple service teams. Accordingly, in some implementations, the plurality of smart contracts may identify a workflow dependency of a first respective service team relative to a second respective service team. For example, assume that a given component change may impact both an operating system service team and a networking service team. Accordingly, the plurality of smart contract may identify that the given component impacts the operating system service team and the plurality of smart contracts may identify that the given component impacts the networking service team. Additionally, the plurality of smart contracts may identify (e.g., based upon information collected during onboarding the operating system service team) that changes in networking also impact the operating system service team. Accordingly, the plurality of smart contracts may identify the given component may doubly impact the operating system service team, both requiring a workflow to support the given component and requiring a workflow to support anything the networking team does to support the given component. Accordingly, the plurality of smart contracts may also identify dependencies amongst the various service teams.

As generally discussed above, impact assessment process 10 may receive 102 one or more component changes associated with a proposed design. For example, assume for the purpose of illustration that in order to provide some new capacity within cloud computing environment (e.g., additional feature sets, compute capacity, etc.) a design team designs a new server rack. Accordingly, the design team may select the various components (e.g., motherboard, processor, chipset, memory, storage device, etc.) of the server rack. Each of the selected component may have a corresponding stock keeping unit (sku), manufacturer and model number, and/or some other unique identifier of each respective component, which may be tracked or compiled via one or more build specifications, or similar document (herein a build specification for the purpose of description). Impact assessment process 10 may receive 102 one or more component changes associated with the proposed design based upon, at least in part, the build specification (and/or other information). In some implementations, impact assessment process 10 may receive 102 the one or more component changes associated with the proposed design at an early stage in the design process. For example, impact assessment process 10 may receive the one or more component changes associated with the new design as the components are selection, as sub-assemblies of the proposed design are established, once the entire proposed design is complete, and/or at a later point in the design and/or development process.

According to an implementation, receiving 102 one or more component changes may include evaluating 106 the proposed design against a catalog of supported components. For example, the sku’s, manufacturer and model numbers, etc. of the various components may be evaluated 106 against a catalog of components that have previously been utilized in connection with the cloud computing environment 200, and/or for which support has already been developed (e.g., to allow for integration into cloud computing environment, lifecycle support, etc.). In some implementations, evaluating 106 the proposed design against a catalog of supported components may include comparing the build specification against inventory control information associated with components that are currently deployed within cloud computing environment 200.

Further receiving 102 one or more component changes associated with the new design may include identifying 108 the one or more component changes as unsupported components. That is, the one or more component changes may include components that are not included within an inventor control information, or other catalog of supported components. As such, the one or more component changes may represent unsupported components, for which support must be provided before the components may be integrated into cloud computing environment 200. It will be appreciated that for any proposed new design at least a portion of the components may include components that are currently supported within cloud computing environment 200. As such, the number of component changes associated with the proposed design may vary. Further, while the illustrative example in which the proposed design may include a server rack, as discussed above, various additional and/or alternative implementations are considered by the present disclose, including implementations in which the unsupported component may include one or more hardware components and/or may include one or more software components, one or more firmware components, and the like.

Impact assessment process 10 validate 104, by at least a portion of the plurality of smart contracts, the one or more component changes against components impacting each respective service team to identify impacts associated with the proposed design. For example, when a proposed design is published (e.g., the design specification, or similar, are made available to impact assessment process 10), impact assessment process 10 may receive 102 one or more component changes associated with the proposed design, as generally discussed above. Upon receiving 102 the one or more component changes associated with the proposed design (e.g., one or more components not currently supported within cloud computing environment 200), the one or more component changes may be validated 104, by at least a portion of the plurality of smart contracts, against the components impacting each respective service team. For example, the one or more component changes may be compared to the identified components impacting each respective service teams to identify impacts associated with the proposed design.

Consistent with some implementations, identifying impacts associated with the proposed design includes identifying 110 one or more respective services teams impacted by the proposed design. That is, for example, any of the service teams that have identified the one or more component changes as impacting the service team may be identified. Additionally, in some implementations, identifying impacts associated with the proposed design may include identifying 112 estimated workflows associated with the proposed design. Consistent with such an implementation, validating 104 the one or more component changes against components impacting each respective service team may not only identify the service teams that may be impacted by the proposed design, but additionally, may identify the estimated workflows for the various impacted service teams. As discussed above, the estimated workflows may be identified 112 at varying levels of granularity (e.g., low, medium or high impact, estimated development time to support the one or more component changes, estimated cost for supporting the one or more component changes, and/or various additional and/or alternative metrics).

As discussed above, one or more of the identified impacts may also include dependencies with respect to one or more other identified impacts associated with the one or more component changes. Accordingly, validating 104 the one or more component changes against components impacting each respective service team may include identifying 114 workflow dependencies associated with at least a first service team relative to at least a second service team. For example, and as generally discussed above, in addition to being directly impacted by a component change, a service team may be impacted by the workflow(s) that the one or more component changes necessitate for one or more other service teams. For example, a feature service team seeking to expose a particular virtual machine size to a customer may not be able to engage in the development work for exposing the particular virtual machine size until the operating system service team has completed their work to manage the one or more changed components and exposed the necessary API’s for the higher level feature service team to build their product.

Consistent with the foregoing, it will be appreciated that when multiple service teams are impacted by the one or more changed components, the workflows required for one service team may be capable of being carried out in parallel with the workflows required for one or more other service team. Further, in some situations, the workflows required for one or more service teams may be required to be in series with the workflows required for one or more other service teams. Accordingly, in some implementations, impact assessment process 10 may build a dependency chain that may identify workflows that can be carried out in parallel and workflows that must be carried out in series. In some implementations, building the dependency chain may include iteratively validating 104 the one or more component changes against component impacting respective service teams and identifying 114 workflow dependences. Further, in some implementations, change components may be identified for which no service team has declared responsibility. For example, a service team may identify that it is dependent upon a component for which no service has declared their support or ownership. Accordingly, impact assessment process 10 may identify missing edges. Further, in some implementations, impact assessment process 10 may enable recommendations to reduce impacts to one or more service teams. In some embodiments, the recommendations aid in reducing the time required to achieve product readiness, for example, by swapping unsupported components for components that are already supported, and by identifying the choke points when a given team is mostly impacted due to multiple misalignments (e.g., the service team is required to support multiple unsupported components, and/or is subject to dependencies) and becomes the bottleneck to enabling the provisioning of such new hardware/products.

Consistent with the foregoing, in some implementations impact assessment process 10 may allow the workflows associated with a proposed design to be fully realized and visualized. In some particular implementations, impact assessment process 10 may allow such impacts associated with a proposed design to be realized early in the design and development process (e.g., including before any production work begins on the proposed design, and/or at another point in the design and development process). As the required workflows may be flagged at a relatively early stage in the design and development process, project management teams may be able to ascertain the full cost and workload required to bring a proposed design into production, and to identify if the impacted service teams have the available bandwidth to accommodate the estimated workflows. Such information may be provided with regard to the proposed design as a whole, as well as for each component change associated with the proposed design. This information may enable project management teams to make decisions such as whether to move forward with the design as a whole, whether to reject the proposed design, whether to move forward with a portion of the proposed design (e.g., as by replacing one or more of the component changes with components that are currently supported in the cloud computing environment), and/or to conduct a staged implementation of the proposed design (e.g., initially moving forward with a portion of the proposed design, and sequentially integrated more of the changed components in one or more stages).

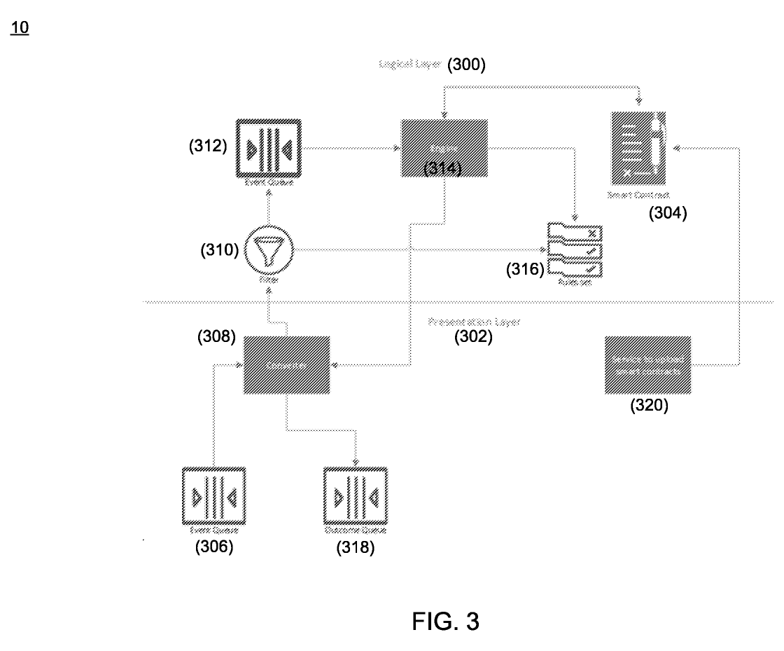

Referring also to FIG. 3, consistent with one implementation, a high-level architecture that may implement impact assessment process 10 is shown. As generally depicted, the high-level architecture may include logical layer 300 and presentation layer 302. Using the combination of the logical layer 300 and the presentation layer 302, impact assessment process 10 may create smart contracts (e.g., which may be stored in smart contract repository 304) that can add formal checkpoints for a development process. For example, when any component published a change (e.g., one or more component changes of a proposed design), the smart contract may broadcast the change to all of the dependencies (e.g., smart contracts associated with various respective service teams). Only after the component change has been validated and the impact of the component change determined and/or visualized will the change be allowed. Consistent with some such implementations, every participant in the impact assessment process may have visibility as to what change and timeline a development process is undergoing. Further, in some implementations, the formal checkpoints for the development process may allow a review of the development process, e.g., potentially including halting the development process if requirements are not satisfied.

Continuing with the example implementation, the smart contract (e.g., which may be stored in smart contract repository 304) may be a piece of software which evaluates contractual compliance given a set of rules and a series of events, e.g., which may be implemented in the form of XML/JSON files. In some embodiments, the files include at least four fields: originator, responder, type, and status. In such an embodiment of the smart contract, the sender and recipient may be the originators and responders of the messages, which are sent between each other. Each of the service teams in the buildout scenario may be assigned an initial set of rights, obligations, and prohibitions. The smart contract is then able to check when each event arrives, and whether the event complies with specified format. If an event is compliant, then the appropriate check is made. Once the event comes in whereby the recipient requests the change of an asset, the sender is assigned the obligation to respond to the request with either a confirmation that the recipient can have the change delivered or a rejection of the change.

Additionally, and continuing with the example embodiment of FIG. 3, the logical layer 300 may be responsible for processing business events and for determining whether they are contract compliant or not. The presentation layer 302 may provide an interface to the logical layer, and may be used for delivering business events to the logical layer 300, and for collecting the corresponding responses. In addition, the presentation layer 302 may be used for loading and editing the clauses of the smart contract 304.

The flow of this example architecture may generally be as follows. Aa event may be received through the event queue 306 of the presentation layer 302, which may include the names of the participants (e.g., service teams), the business operation, and its outcome. In some implementations, a new proposed design may be submitted to the event queue. That document may be then sent through the converter 308 to the logical layer. In general, the converter 308 may convert events submitted via the input queue 306 into machine readable format, and may similarly convert outputs from the logical layer 300 into human readable format. The filter 310 may discard mismatched events that are not among the permitted events defined within the rules set. For example, filter 310 may receive inputs from converter 308, and may validate the input against a rule set. In one example, if a received change notification is unallowed, the filter 310 may prevent further action on the unallowed change notification, as there may be no point in fully assessing an impact of an unallowed change. If it is determined that the change needs to be supported, the service teams will need to make changes to their existing smart contracts to allow the change. The changes made by the service teams to their smart contracts will, in turn, result in updating the rule sets (discussed below in greater detail).

Events that pass this filter 310 are inserted into the event queue 312 of the logical layer 300. The event queue 312 may, for example, be responsible for pushing relevant planned changes (e.g., which may be in an event format from an event consumption perspective) to the main engine 314. In general, the engine 314 may be responsible for ensuring that smart contract details are read, dependencies are calculated, and that the rules set may be appropriately updated, as necessary. In some implementations, the engine 314 may receive inputs, such as new hardware information, or a change in existing hardware information. Based, at least in part, upon such inputs, the engine 314 computes the details of the change (e.g., of the proposed new design) and the corresponding impact analysis and dependency analysis. The engine may provide an output regarding whether the change is allowed or not, and what the impact of the change would be. This output may, in some implementations, be provided to a planning team and/or project management team. Accordingly, in some implementations, the engine 314 removes an event from the head of the event queue 312 and compares it to the rules (e.g., rules set 316) stored in the smart contract 304. Rules that match the event under examination are triggered to determine if their conditions are satisfied. The actions of the rules whose conditions are satisfied are executed, and this may alter (add/delete) the current state of the rules set. The rule also will add (impose) an obligation on the Recipient to either initiate the execution of Execute or initiate the execution of Cancel. The event can be stored in an event logger as a record for any future dispute resolution. The engine 314 eventually declares the event either compliant or non-compliant and produces a response, which is sent out to the presentation layer 302 in the outcome queue 318. The various service teams may provide the implementation of contracts as well as the components that impact the respective service teams via service 320. For example, service 320 may provide services to implement and provide smart contracts.

Consistent with the foregoing example, in some implementation, the engine 314 may evaluate the smart contracts (e.g., smart contract 304) an identify all of the components that will impact each respective service team, and what each impact may be, as well as what the aggregate of all of the impacts for a proposed design may be. Accordingly, in some implementations, the engine 314 may identify the costs and workflows necessary to bring a proposed design to full deployment. This information may be provided before full development and deployment of the proposed design, thereby allowing decisions and planning to take place early in the process. Additionally, in some implementations, the engine 314 may identify the most impacted service teams, as well as making recommendations, such as if a given change component is eliminated (e.g., replaced with a component already supported within the cloud computing environment) impacts may be reduced by an identified amount, or ranking how much the impacts may be reduced by eliminating different ones of a plurality of component changes.

### System Overview

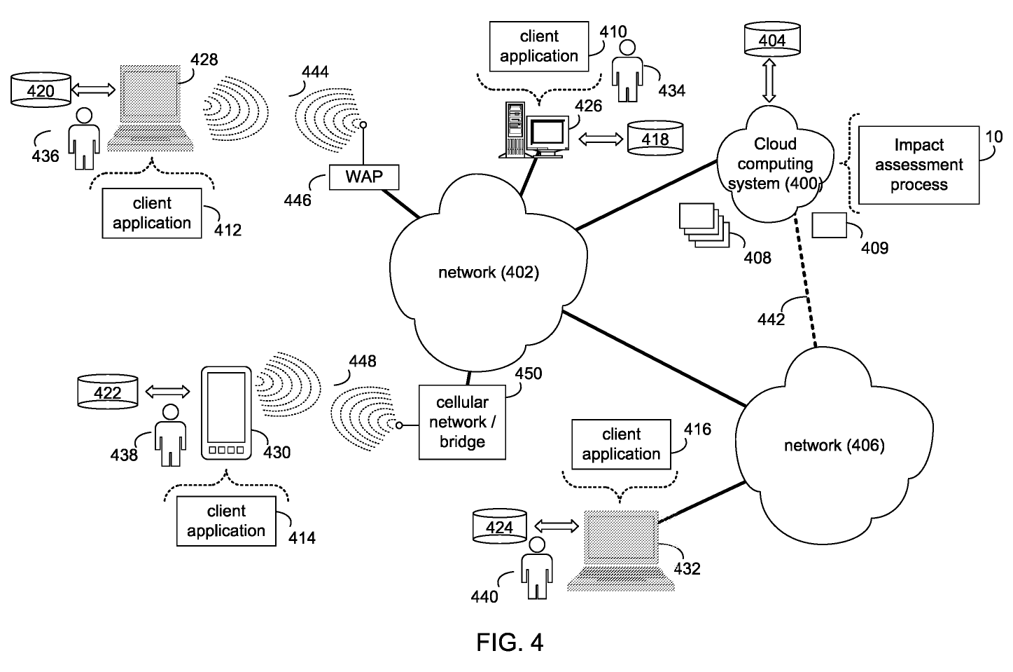

Referring to FIG. 4, an impact assessment process 10 is shown to reside on and is executed by cloud computing system 400, which is connected to network 402 (e.g., the Internet or a local area network). Examples of cloud computing system 400 include: a server array, a Network Attached Storage (NAS) system, a Storage Area Network (SAN), a personal computer with a memory system, a server computer with a memory system, and a cloud-based device with a memory system. A SAN includes one or more of a personal computer, a server computer, a series of server computers, a minicomputer, a mainframe computer, a RAID device, and a NAS system.

The various components of cloud computing system 400 execute one or more operating systems, examples of which include: Microsoft® Windows®; Mac® OS X®; Red Hat® Linux®, Windows® Mobile, Chrome OS, Blackberry OS, Fire OS, or a custom operating system (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of impact assessment process 10, which are stored on storage device 404 included within cloud computing system 400, are executed by one or more processors (not shown) and one or more memory architectures (not shown) included within cloud computing system 400. Storage device 404 may include: a hard disk drive; an optical drive; a RAID device; a random-access memory (RAM); a read-only memory (ROM); and all forms of flash memory storage devices. Additionally or alternatively, some portions of the instruction sets and subroutines of impact assessment process 10 are stored on storage devices (and/or executed by processors and memory architectures) that are external to cloud computing system 400.

In some implementations, network 402 is connected to one or more secondary networks (e.g., network 406), examples of which include: a local area network; a wide area network; or an intranet.

Various smart contracts (e.g., smart contracts 408) are sent from, and/or may be at least in part generated based on interactions with, client applications 410, 412, 414, 416 to cloud computing system 400.

The instruction sets and subroutines of client applications 410, 412, 414, 416, which may be stored on storage devices 418, 420, 422, 424 (respectively) coupled to client electronic devices 426, 428, 430, 432 (respectively), may be executed by one or more processors (not shown) and one or more memory architectures (not shown) incorporated into client electronic devices 426, 428, 430, 432 (respectively). Storage devices 418, 420, 422, 424 may include: hard disk drives; tape drives; optical drives; RAID devices; random access memories (RAM); read-only memories (ROM), and all forms of flash memory storage devices. Examples of client electronic devices 426, 428, 430, 432 include personal computer 426, laptop computer 428, smartphone 430, laptop computer 432, a server (not shown), a data-enabled, and a dedicated network device (not shown). Client electronic devices 426, 428, 430, 432 each execute an operating system.

Users 434, 436, 438, 440 may access cloud computing system 400 directly through network 402 or through secondary network 406. Further, cloud computing system 400 may be connected to network 402 through secondary network 406, as illustrated with link line 442.

The various client electronic devices may be directly or indirectly coupled to network 402 (or network 406). For example, personal computer 426 is shown directly coupled to network 402 via a hardwired network connection. Further, laptop computer 432 is shown directly coupled to network 406 via a hardwired network connection. Laptop computer 428 is shown wirelessly coupled to network 402 via wireless communication channel 444 established between laptop computer 428 and wireless access point (e.g., WAP) 446, which is shown directly coupled to network 402. WAP 446 may be, for example, an IEEE 802.11a, 802.11b, 802.11g, 802.11n, Wi-Fi®, and/or Bluetooth® device that is capable of establishing a wireless communication channel 444 between laptop computer 428 and WAP 446. Smartphone 430 is shown wirelessly coupled to network 402 via wireless communication channel 448 established between smartphone 430 and cellular network / bridge 450, which is shown directly coupled to network 402.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be used. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language. However, the computer program code for carrying out operations of the present disclosure may also be written in conventional procedural programming languages, such as the “C” programming language or similar programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through a local area network / a wide area network / the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer / special purpose computer / other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, not at all, or in any combination with any other flowcharts depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
generating a plurality of smart contracts, each of the plurality of smart contracts associated with a respective service team, and each of the plurality of smart contracts identifying components impacting each respective service team;
receiving one or more component changes associated with a proposed design; and
validating, by at least a portion of the plurality of smart contracts, the one or more component changes against components impacting each respective service team to identify impacts associated with the proposed design.

2. The computer-implemented method according to claim 1, wherein each of the plurality of smart contracts identify an impact associated with the respective service team.

3. The computer-implemented method according to claim 2, wherein the impact associated with respective service team includes an estimated workflow assessment associated with respective service team.

4. The computer-implemented method according to claim 1, wherein the plurality of smart contracts identify a workflow dependency of a first respective service team relative to a second respective service team.

5. The computer-implemented method according to claim 1, wherein receiving one or more component changes includes:
evaluating the proposed design against a catalog of supported components; and
identifying the one or more component changes as unsupported components.

6. The computer-implemented method according to claim 5, wherein the unsupported components include one or more of hardware components and software components.

7. The computer-implemented method according claim 1, wherein identifying impacts associated with the proposed design includes one or more of:
identifying one or more respective services teams impacted by the proposed design;
identifying estimated workflows associated with the proposed design; and
identifying workflow dependencies associated with at least a first service team relative to at least a second service team.

8. A computing system comprising:
a memory; and
a processor configured to generate a plurality of smart contracts, each of the plurality of smart contracts associated with a respective service team, and each of the plurality of smart contracts identifying components impacting each respective service team, receive one or more component changes associated with a proposed design, and validate, by at least a portion of the plurality of smart contracts, the one or more component changes against components impacting each respective service team to identify impacts associated with the proposed design.

9. The computing system according to claim 8, wherein each of the plurality of smart contracts identify an impact associated with the respective service team.

10. The computing system according to claim 9, wherein the impact associated with respective service team includes an estimated workflow assessment associated with respective service team.

11. The computing system according to claim 8, wherein the plurality of smart contracts identify a workflow dependency of a first respective service team relative to a second respective service team.

12. The computing system according to claim 8, wherein the processor configured to receive one or more component changes is further configured to:
evaluate the proposed design against a catalog of supported components; and
identify the one or more component changes as unsupported components.

13. The computing system according to claim 12, wherein the unsupported components include one or more of hardware components and software components.

14. The computing system according claim 8, wherein the processor configured to identify impacts associated with the proposed design is further configured to one or more of:
identify one or more respective services teams impacted by the proposed design;
identify estimated workflows associated with the proposed design; and
identify workflow dependencies associated with at least a first service team relative to at least a second service team.

15. A computer program product residing on a non-transitory computer readable medium, which, when executed by a processor, causes the processor to perform operations comprising:
generating a plurality of smart contracts, each of the plurality of smart contracts associated with a respective service team, and each of the plurality of smart contracts identifying components impacting each respective service team;
receiving one or more component changes associated with a proposed design; and
validating, by at least a portion of the plurality of smart contracts, the one or more component changes against components impacting each respective service team to identify impacts associated with the proposed design.

16. The computer program product according to claim 15, wherein each of the plurality of smart contracts identify an impact associated with the respective service team.

17. The computer program product according to claim 16, wherein the impact associated with respective service team includes an estimated workflow assessment associated with respective service team.

18. The computer program product according to claim 15, wherein the plurality of smart contracts identify a workflow dependency of a first respective service team relative to a second respective service team.

19. The computer program product according to claim 15, wherein receiving one or more component changes includes:
evaluating the proposed design against a catalog of supported components; and
identifying the one or more component changes as unsupported components.

20. The computer program product according claim 15, wherein identifying impacts associated with the proposed design includes one or more of:
identifying one or more respective services teams impacted by the proposed design;
identifying estimated workflows associated with the proposed design; and
identifying workflow dependencies associated with at least a first service team relative to at least a second service team.
